(19) United States
(12) Patent Application Publication
(10) Pub. No.: US 2025/0254632 A1
(43) Pub. Date: Aug. 7, 2025

(54) POWER CONFIGURATION SHARING BETWEEN SIDELINK USER EQUIPMENT (SL UES)

(71) Applicant: QUALCOMM Incorporated, San Diego, CA (US)

(72) Inventors: Marwen Zorgui, San Diego, CA (US); Alexandros Manolakos, Athens (GR); Srinivas Yerramalli, San Diego, CA (US)

(21) Appl. No.: 18/855,200

(22) PCT Filed: May 4, 2023
(86) PCT No.: PCT/US2023/066618

§ 371 Date: Oct. 8, 2024

(30) Foreign Application Priority Data
Jun. 22, 2022 (GR) 20220100507

(51) Int. Cl. H04W 52/32; H04W 52/24; H04W 52/28; H04W 92/18

(52) U.S. Cl. CPC H04W 52/325; H04W 52/242; H04W 52/283; H04W 92/18

(57) ABSTRACT

This disclosure provides systems, methods, and devices for wireless communication that support power control for sidelink communications, including positioning operations using sidelinks. In a first aspect, a method of wireless communication includes retrieving, by the first UE, first information regarding power control for a sidelink transmission; and transmitting, by the first UE to a second UE, at least one indicator based on the first information. Other aspects and features are also claimed and described.

### CROSS-REFERENCE TO RELATED APPLICATIONS

This application claims priority to international Greek application No. 20220100507, entitled “POWER CONFIGURATION SHARING BETWEEN SIDELINK USER EQUIPMENT (SL UES),” filed Jun. 22, 2022, the disclosure of which is hereby incorporated herein by reference.

### TECHNICAL FIELD

Aspects of the present disclosure relate generally to wireless communication systems, and more particularly, to sidelinks. Some features may enable and provide improved communications, including transmit power control on sidelinks.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

As more UEs access wireless communication networks, power control becomes a more important consideration. Each UE becomes a potential interferer by having a transmitter that may transmit signals that jam another UE's or BS's transmission. Further, UEs outside of coverage of the wireless communication networks may nevertheless cause interference to access links in the wireless communication network.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes retrieving, by the first UE, first information regarding power control for a sidelink transmission; and transmitting, by the first UE to a second UE, at least one indicator based on the first information. The wireless communications method may provide for power control over sidelink transmissions and support positioning operations based on the sidelink transmissions, including positioning operations using a side link positioning reference signal (SL PRS).

In an additional aspect of the disclosure, an apparatus includes at least one processor and a memory coupled to the at least one processor. The at least one processor is configured to perform operations including retrieving, by the first UE, first information regarding power control for a sidelink transmission; and transmitting, by the first UE to a second UE, at least one indicator based on the first information.

In an additional aspect of the disclosure, an apparatus includes means for retrieving, by the first UE, first information regarding power control for a sidelink transmission; and means for transmitting, by the first UE to a second UE, at least one indicator based on the first information.

In an additional aspect of the disclosure, a non-transitory computer-readable medium stores instructions that, when executed by a processor, cause the processor to perform operations. The operations include retrieving, by the first UE, first information regarding power control for a sidelink transmission; and transmitting, by the first UE to a second UE, at least one indicator based on the first information.

In one aspect of the disclosure, a method for wireless communication includes receiving, from a first UE at a second UE, first information regarding power control for a sidelink transmission; and transmitting, by the second UE, on the sidelink transmission according to the first information regarding power control for the sidelink transmission.

In an additional aspect of the disclosure, an apparatus includes at least one processor and a memory coupled to the at least one processor. The at least one processor is configured to perform operations including receiving, from a first UE at a second UE, first information regarding power control for a sidelink transmission; and transmitting, by the second UE, on the sidelink transmission according to the first information regarding power control for the sidelink transmission.

In an additional aspect of the disclosure, an apparatus includes means for receiving, from a first UE at a second UE, first information regarding power control for a sidelink transmission; and means for transmitting, by the second UE, on the sidelink transmission according to the first information regarding power control for the sidelink transmission.

In an additional aspect of the disclosure, a non-transitory computer-readable medium stores instructions that, when executed by a processor, cause the processor to perform operations. The operations include receiving, from a first UE at a second UE, first information regarding power control for a sidelink transmission; and transmitting, by the second UE, on the sidelink transmission according to the first information regarding power control for the sidelink transmission.

In one aspect, a first UE shares SL PRS power parameters with a second UE using a cluster-based approach or a zone-based approach. In another aspect, the initiator anchor (the UE initiating a positioning session) includes, in an initialization message, power control parameters, and the responding anchors include, in their responsive messages, power control parameters used for SL-PRS transmissions. In another aspect, a target device may send a unicast, broadcast, or a multicast message with requests to change power control parameters. The target device may send the message to the Init-Anchor, which updates power control parameters to other relevant participating devices.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIGS. 3A and 3B illustrate example wireless network structures, according to one or more aspects.

FIG. 4 illustrates an example of a wireless communications system that supports unicast sidelink establishment, according to one or more aspects.

FIG. 5 is a diagram illustrating an example frame structure for use in a wireless telecommunications system, according to one or more aspects.

FIG. 6 is a block diagram illustrating an example wireless communication system that supports transmission of power control configuration information according to one or more aspects.

FIG. 7 is a flow diagram illustrating an example process that supports transmitting power control configuration information on a sideline according to one or more aspects.

FIG. 8 is a flow diagram illustrating an example process that supports receiving power control configuration information on a sideline for configuring a UE according to one or more aspects.

FIG. 9 is a diagram illustrating an example communication system for sidelink communications of power control parameters used for sidelink positioning reference signals (SL-PRS) transmissions according to one or more aspects.

FIG. 10 is a block diagram of an example UE that supports sidelink communications according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support sidelink operations. Power control information, such as a configuration and/or associated parameters, may be shared between UEs over sidelinks. One example use of a sidelink is for sharing of parameters that may be used in positioning of a UE or other mobile device. The positioning reference signal (PRS) may be transmitted by a UE according to power control information shared from other nearby UEs. Another UE or mobile device may receive the PRS signal and make measurements based on the PRS to assist in determining a position of the UE or mobile device. In some embodiments, one or more UEs that receive the power information over SL may be an out of coverage node.

Particular implementations of the subject matter described in this disclosure may be implemented to realize one or more of the following potential advantages or benefits. In some aspects, the present disclosure provides techniques for sidelink (SL) positioning. In SL positioning, a SL UE transmits a SL PRS, which is received by other SL UEs. The SL PRS may be used to determine location of one or more UEs in the wireless network. Determining an appropriate SL PRS transmit power level can improve the positioning process (in reducing time used to locate position and in increasing accuracy of the position), in addition to saving SL UE power, and reducing potential interference caused by a SL PRS transmission at too-high power levels. A SL UE transmitting a SL PRS may determine the appropriate SL PRS transmit power level in a quicker and/or more accurate manner by receiving SL PRS power configuration from nearby UEs and basing its own SL PRS transmit power level on the received SL PRS power configuration. Thus, the sharing of power information for a sidelink and controlling transmissions on the sidelink according to aspects of his disclosure may improve SL positioning and otherwise improve operation on the sidelink.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

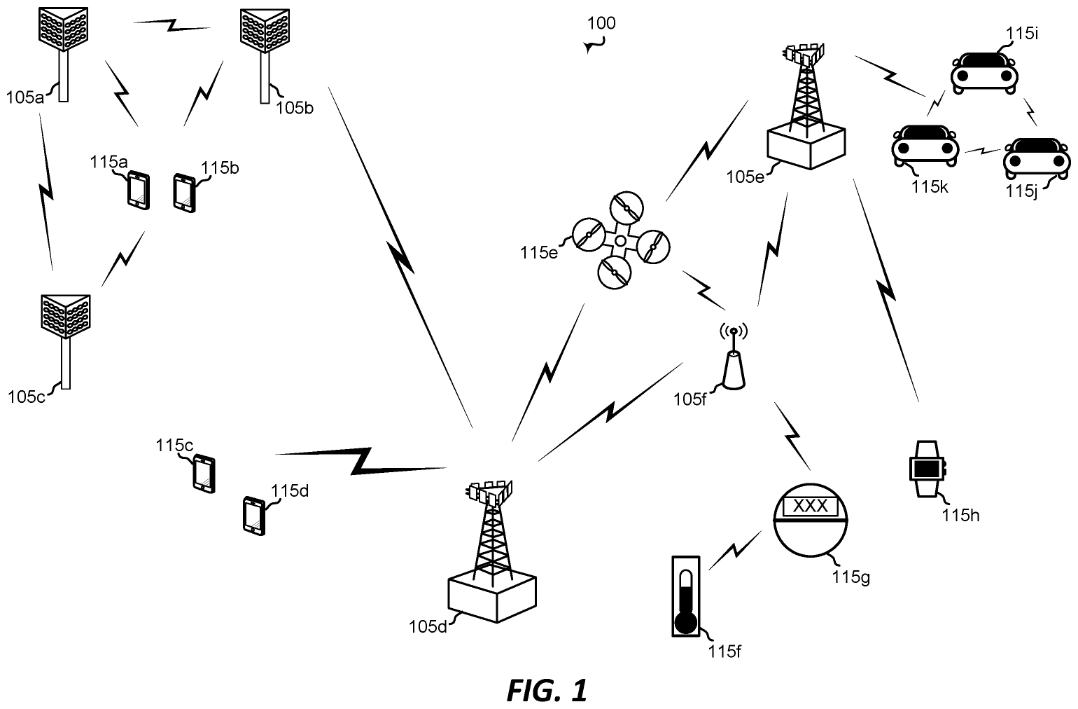

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

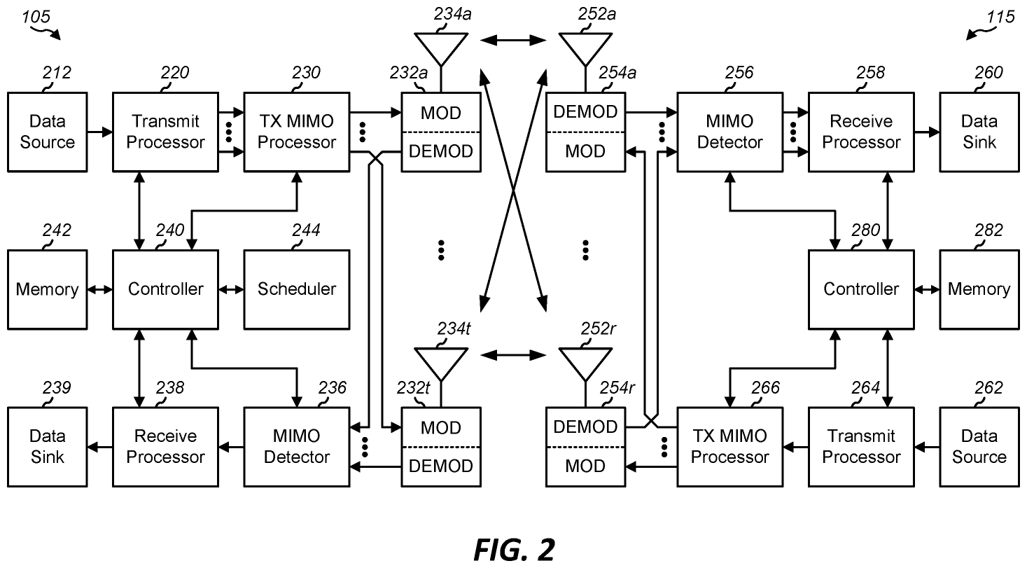

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

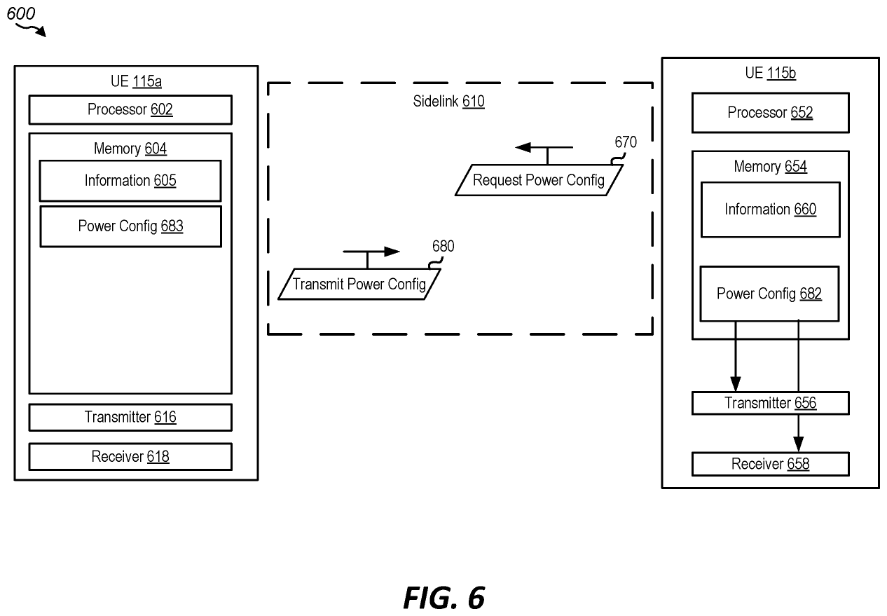

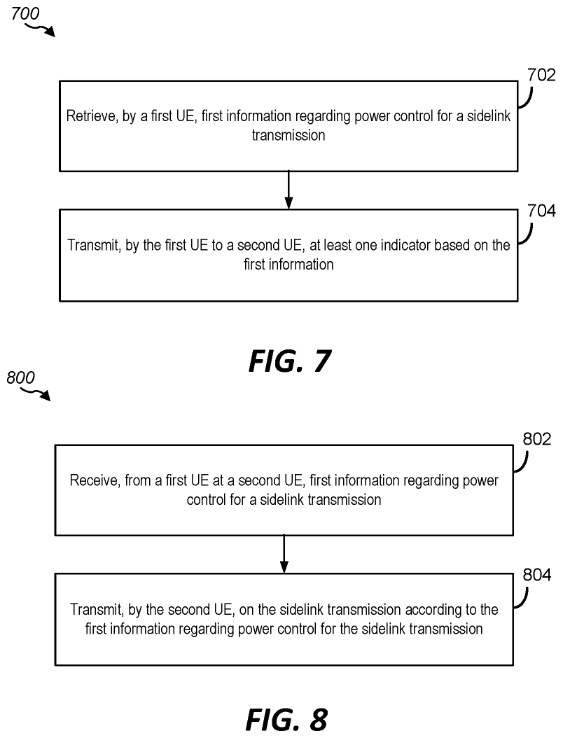

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 7-8, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Although aspects of communications between base station 105 and UE 115 are described with reference to FIGS. 1-2, the disclosed techniques and components may likewise be used to communicate between UEs, such as UE 105a and UE 105b. Such communications may be performed over connections referred to as sidelinks.

A wireless sidelink (or just “sidelink”) may be an adaptation of the core cellular (e.g., LTE, NR) standard that allows direct communication between two or more UEs without communicating through a base station. Sidelink communication may be unicast or multicast, and may be used, for example, in applications such as device-to-device (D2D) media-sharing, V2V (vehicle-to-vehicle) communication, V2X communication (e.g., cellular V2X (cV2X) communication, enhanced V2X (eV2X) communication, etc.), emergency rescue applications, etc. One or more of a group of UEs 115 using sidelink communications may be within the geographic coverage area of a base station 105. Other UEs 115 in such a group may be outside the geographic coverage area of a base station 105 or be otherwise unable to receive transmissions from a base station 105. In some cases, groups of UEs 115 communicating via sidelink communications may use a one-to-many (1:M) system in which each UE 115 transmits to every other UE 115 in the group. In some cases, a base station 105 facilitates the scheduling of resources for sidelink communications. In other cases, sidelink communications are carried out between UEs 115 without the involvement of a base station 105.

Vehicles communicating on the network may be referred to as vehicle UEs or V-UEs. Communications between V-UEs are referred to as V2V communications, communications between V-UEs and roadside access points are referred to as V2I communications, and communications between V-UEs and UEs 115 (where the UEs 115 are P-UEs) are referred to as V2P communications. The V2V communications between V-UEs may include, for example, information about the position, speed, acceleration, heading, and other vehicle data of the V-UEs. The V2I information received at a V-UE from the one or more roadside access points may include, for example, road rules, parking automation information, etc. The V2P communications between a V-UE and a UE 104 may include information about, for example, the position, speed, acceleration, and heading of the V-UE and the position, speed (e.g., where the UE is carried by a user on a bicycle), and heading of the UE.

The sidelinks may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks may correspond to at least a portion of the licensed ITS frequency band of sub-6 GHz. However, the present disclosure is not limited to this frequency band or cellular technology.

In an aspect, the sidelinks may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHZ (5.85-5.925 GHZ) in the U.S. In Europe, IEEE 802.11p operates in the ITS GSA band (5.875-5.905 MHZ). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHZ) is intended for other services of interest to drivers, such as road rules, tolling, parking automation, etc. Thus, as a particular example, the mediums of interest utilized by sidelinks may correspond to at least a portion of the licensed ITS frequency band of 5.9 GHZ.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-MI) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

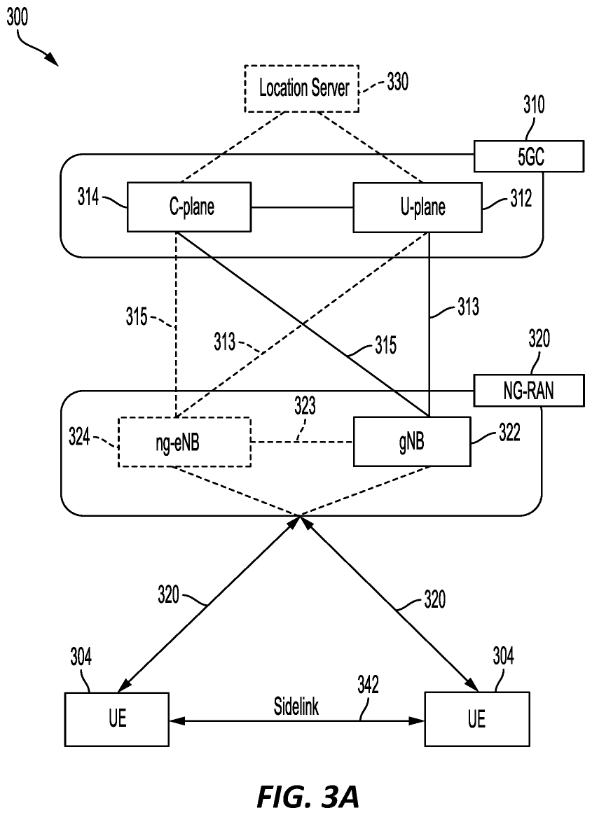

FIG. 3A illustrates an example wireless network structure 300. For example, a 5GC 310 (also referred to as a Next Generation Core (NGC)) can be viewed functionally as control plane functions (C-plane) 314 (e.g., UE registration, authentication, network access, gateway selection, etc.) and user plane functions (U-plane) 312 (e.g., UE gateway function, access to data networks, IP routing, etc.), which operate cooperatively to form the core network. User plane interface (NG-U) 313 and control plane interface (NG-C) 315 connect the gNB 322 to the 5GC 310 and specifically to the user plane functions 312 and control plane functions 314, respectively. In an additional configuration, an ng-eNB 324 may also be connected to the 5GC 310 via NG-C 315 to the control plane functions 314 and NG-U 313 to user plane functions 312. Further, ng-eNB 324 may directly communicate with gNB 322 via a backhaul connection 323. In some configurations, a Next Generation RAN (NG-RAN) 320 may only have one or more gNBs 322, while other configurations include one or more of both ng-eNBs 324 and gNBs 322. Either (or both) gNB 322 or ng-eNB 324 may communicate with UEs 304 (e.g., any of the UEs described herein). In an aspect, two or more UEs 304 may communicate with each other over a wireless sidelink 342, which may correspond to any of the wireless sidelinks described herein.

Another optional aspect may include location server 330, which may be in communication with the 5GC 310 to provide location assistance for UEs 304. The location server 330 can be implemented as a plurality of separate servers (e.g., physically separate servers, different software modules on a single server, different software modules spread across multiple physical servers, etc.), or alternately may each correspond to a single server. The location server 330 can be configured to support one or more location services for UEs 304 that can connect to the location server 330 via the core network, 5GC 310, and/or via the Internet (not illustrated). Further, the location server 330 may be integrated into a component of the core network, or alternatively may be external to the core network.

FIG. 3B illustrates another example wireless network structure 350. For example, a 5GC 360 can be viewed functionally as control plane functions, provided by an access and mobility management function (AMF) 364, and user plane functions, provided by a user plane function (UPF) 362, which operate cooperatively to form the core network (i.e., 5GC 360). User plane interface 363 and control plane interface 365 connect the ng-eNB 324 to the 5GC 360 and specifically to UPF 362 and AMF 364, respectively. In an additional configuration, a gNB 322 may also be connected to the 5GC 360 via control plane interface 365 to AMF 364 and user plane interface 363 to UPF 362. Further, ng-eNB 324 may directly communicate with gNB 322 via the backhaul connection 323, with or without gNB direct connectivity to the 5GC 360. In some configurations, the NG-RAN 320 may only have one or more gNBs 322, while other configurations include one or more of both ng-eNBs 324 and gNBs 322. The base stations of the NG-RAN 320 communicate with the AMF 364 over the N2 interface and with the UPF 362 over the N3 interface. Either (or both) gNB 322 or ng-eNB 324 may communicate with UEs 304 (e.g., any of the UEs described herein). In an aspect, two or more UEs 304 may communicate with each other over a sidelink 342, which may correspond to any of the wireless sidelinks described herein.

The functions of the AMF 364 include registration management, connection management, reachability management, mobility management, lawful interception, transport for session management (SM) messages between the UE 304 and a session management function (SMF) 366, transparent proxy services for routing SM messages, access authentication and access authorization, transport for short message service (SMS) messages between the UE 304 and the short message service function (SMSF) (not shown), and security anchor functionality (SEAF). The AMF 364 also interacts with an authentication server function (AUSF) (not shown) and the UE 304, and receives the intermediate key that was established as a result of the UE 304 authentication process. In the case of authentication based on a UMTS (universal mobile telecommunications system) subscriber identity module (USIM), the AMF 364 retrieves the security material from the AUSF. The functions of the AMF 364 also include security context management (SCM). The SCM receives a key from the SEAF that it uses to derive access-network specific keys. The functionality of the AMF 364 also includes location services management for regulatory services, transport for location services messages between the UE 304 and a location management function (LMF) 370 which acts as a location server 330, transport for location services messages between the NG-RAN 320 and the LMF 370, evolved packet system (EPS) bearer identifier allocation for interworking with the EPS, and UE 304 mobility event notification. In addition, the AMF 364 also supports functionalities for non-3GPP (Third Generation Partnership Project) access networks.

Functions of the UPF 362 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 362 may also support transfer of location services messages over a user plane between the UE 304 and a location server such as a secure user plane location (SUPL) location platform (SLP) 372.

The functions of the SMF 366 include session management, UE Internet protocol (IP) address allocation and management, selection and control of user plane functions, configuration of traffic steering at the UPF 362 to route traffic to the proper destination, control of part of policy enforcement and QoS, and downlink data notification. The interface over which the SMF 366 communicates with the AMF 364 is referred to as the N11 interface.

Another optional aspect may include an LMF 370, which may be in communication with the 5GC 360 to provide location assistance for UEs 304. The LMF 370 can be implemented as a plurality of separate servers (e.g., physically separate servers, different software modules on a single server, different software modules spread across multiple physical servers, etc.), or alternately may each correspond to a single server. The LMF 370 can be configured to support one or more location services for UEs 304 that can connect to the LMF 370 via the core network, 5GC 360, and/or via the Internet (not illustrated). The SLP 372 may support similar functions to the LMF 370 but, whereas the LMF 370 may communicate with the AMF 364, NG-RAN 320, and UEs 304 over a control plane (e.g., using interfaces and protocols intended to convey signaling messages and not voice or data), the SLP 372 may communicate with UEs 304 and external clients (not shown in FIG. 3B) over a user plane (e.g. using protocols intended to carry voice and/or data like the transmission control protocol (TCP) and/or IP).

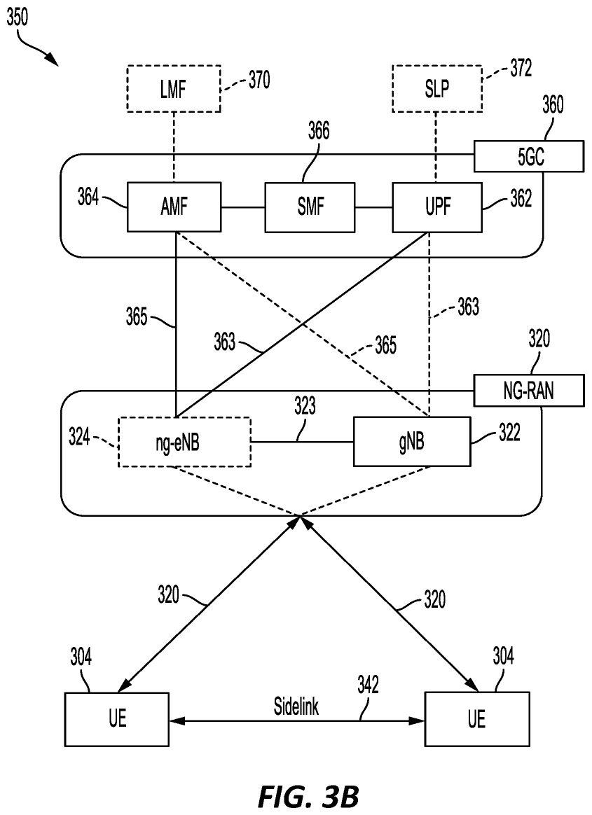

FIG. 4 illustrates an example of a wireless communications system 400 that supports wireless unicast sidelink establishment, according to aspects of the disclosure. In some examples, wireless communications system 400 may implement aspects of wireless communications systems 100, 300, and 350. Wireless communications system 400 may include a first UE 402 and a second UE 404, which may be examples of any of the UEs described herein. As specific examples, UEs 402 and 404 may correspond to V-UEs, UEs 115 in FIG. 1 connected over D2D P2P link, or UEs 304 in FIGS. 3A and 3B.

In the example of FIG. 4, the UE 402 may attempt to establish a unicast connection over a sidelink with the UE 404, which may be a V2X sidelink between the UE 402 and UE 404. As specific examples, the established sidelink connection may correspond to sidelink 342 in FIGS. 3A and 3B. The sidelink connection may be established in an omni-directional frequency range (e.g., FR1) and/or a mmW frequency range (e.g., FR2). In some cases, the UE 402 may be referred to as an initiating UE that initiates the sidelink connection procedure, and the UE 404 may be referred to as a target UE that is targeted for the sidelink connection procedure by the initiating UE.

For establishing the unicast connection, access stratum (AS) (a functional layer in the UMTS and LTE protocol stacks between the RAN and the UE that is responsible for transporting data over wireless links and managing radio resources, and which is part of Layer 2) parameters may be configured and negotiated between the UE 402 and UE 404. For example, a transmission and reception capability matching may be negotiated between the UE 402 and UE 404. Each UE may have different capabilities (e.g., transmission and reception, 64 quadrature amplitude modulation (QAM), transmission diversity, carrier aggregation (CA), supported communications frequency band(s), etc.). In some cases, different services may be supported at the upper layers of corresponding protocol stacks for UE 402 and UE 404. Additionally, a security association may be established between UE 402 and UE 404 for the unicast connection. Unicast traffic may benefit from security protection at a link level (e.g., integrity protection). Security requirements may differ for different wireless communications systems. For example, V2X and Uu systems may have different security requirements (e.g., Uu security does not include confidentiality protection). Additionally, IP configurations (e.g., IP versions, addresses, etc.) may be negotiated for the unicast connection between UE 402 and UE 404.

In some cases, UE 404 may create a service announcement (e.g., a service capability message) to transmit over a cellular network (e.g., cV2X) to assist the sidelink connection establishment. Conventionally, UE 402 may identify and locate candidates for sidelink communications based on a basic service message (BSM) broadcasted unencrypted by nearby UEs (e.g., UE 404). The BSM may include location information, security and identity information, and vehicle information (e.g., speed, maneuver, size, etc.) for the corresponding UE. However, for different wireless communications systems (e.g., D2D or V2X communications), a discovery channel may not be configured so that UE 402 is able to detect the BSM(s). Accordingly, the service announcement transmitted by UE 404 and other nearby UEs (e.g., a discovery signal) may be an upper layer signal and broadcasted (e.g., in an NR sidelink broadcast). In some cases, the UE 404 may include one or more parameters for itself in the service announcement, including connection parameters and/or capabilities it possesses. The UE 402 may then monitor for and receive the broadcasted service announcement to identify potential UEs for corresponding sidelink connections. In some cases, the UE 402 may identify the potential UEs based on the capabilities each UE indicates in their respective service announcements.

The service announcement may include information to assist the UE 402 (e.g., or any initiating UE) to identify the UE transmitting the service announcement (UE 404 in the example of FIG. 4). For example, the service announcement may include channel information where direct communication requests may be sent. In some cases, the channel information may be RAT-specific (e.g., specific to LTE or NR) and may include a resource pool within which UE 402 transmits the communication request. Additionally, the service announcement may include a specific destination address for the UE (e.g., a Layer 2 destination address) if the destination address is different from the current address (e.g., the address of the streaming provider or UE transmitting the service announcement). The service announcement may also include a network or transport layer for the UE 402 to transmit a communication request on. For example, the network layer (also referred to as “Layer 3” or “L3”) or the transport layer (also referred to as “Layer 4” or “L4”) may indicate a port number of an application for the UE transmitting the service announcement. In some cases, no IP addressing may be needed if the signaling (e.g., PC5 signaling) carries a protocol (e.g., a real-time transport protocol (RTP)) directly or gives a locally-generated random protocol. Additionally, the service announcement may include a type of protocol for credential establishment and QoS-related parameters.

After identifying a potential sidelink connection target (UE 404 in the example of FIG. 4), the initiating UE (UE 402 in the example of FIG. 4) may transmit a connection request 415 to the identified target UE 404. In some cases, the connection request 415 may be a first RRC message transmitted by the UE 402 to request a unicast connection with the UE 404 (e.g., an “RRCDirectConnectionSetupRequest” message). For example, the unicast connection may utilize the PC5 interface for the sidelink, and the connection request 415 may be an RRC connection setup request message. Additionally, the UE 402 may use a sidelink signaling radio bearer 405 to transport the connection request 415.

After receiving the connection request 415, the UE 404 may determine whether to accept or reject the connection request 415. The UE 404 may base this determination on a transmission/reception capability, an ability to accommodate the unicast connection over the sidelink, a particular service indicated for the unicast connection, the contents to be transmitted over the unicast connection, or a combination thereof. For example, if the UE 402 wants to use a first RAT to transmit or receive data, but the UE 404 does not support the first RAT, then the UE 404 may reject the connection request 415. Additionally or alternatively, the UE 404 may reject the connection request 415 based on being unable to accommodate the unicast connection over the sidelink due to limited radio resources, a scheduling issue, etc. Accordingly, the UE 404 may transmit an indication of whether the request is accepted or rejected in a connection response 420. Similar to the UE 402 and the connection request 415, the UE 404 may use a sidelink signaling radio bearer 410 to transport the connection response 420. Additionally, the connection response 420 may be a second RRC message transmitted by the UE 404 in response to the connection request 415 (e.g., an “RRCDirectConnectionResponse” message).

In some cases, sidelink signaling radio bearers 405 and 410 may be the same sidelink signaling radio bearer or may be separate sidelink signaling radio bearers. Accordingly, a radio link control (RLC) layer acknowledged mode (AM) may be used for sidelink signaling radio bearers 405 and 410. A UE that supports the unicast connection may listen on a logical channel associated with the sidelink signaling radio bearers. In some cases, the AS layer (i.e., Layer 2) may pass information directly through RRC signaling (e.g., control plane) instead of a V2X layer (e.g., data plane).

If the connection response 420 indicates that the UE 304 accepted the connection request 415, the UE 402 may then transmit a connection establishment 425 message on the sidelink signaling radio bearer 405 to indicate that the unicast connection setup is complete. In some cases, the connection establishment 425 may be a third RRC message (e.g., an “RRCDirectConnectionSetupComplete” message). Each of the connection request 415, the connection response 420, and the connection establishment 425 may use a basic capability when being transported from one UE to the other UE to enable each UE to be able to receive and decode the corresponding transmission (e.g., the RRC messages).

Additionally, identifiers may be used for each of the connection request 415, the connection response 420, and the connection establishment 425. For example, the identifiers may indicate which UE 402/404 is transmitting which message and/or for which UE 402/404 the message is intended. For physical (PHY) layer channels, the RRC signaling and any subsequent data transmissions may use the same identifier (e.g., Layer 2 IDs). However, for logical channels, the identifiers may be separate for the RRC signaling and for the data transmissions. For example, on the logical channels, the RRC signaling and the data transmissions may be treated differently and have different acknowledgement (ACK) feedback messaging. In some cases, for the RRC messaging, a physical layer ACK may be used for ensuring the corresponding messages are transmitted and received properly.

One or more information elements may be included in the connection request 415 and/or the connection response 420 for UE 402 and/or UE 404, respectively, to enable negotiation of corresponding AS layer parameters for the unicast connection. For example, the UE 402 and/or UE 404 may include packet data convergence protocol (PDCP) parameters in a corresponding unicast connection setup message to set a PDCP context for the unicast connection. In some cases, the PDCP context may indicate whether or not PDCP duplication is utilized for the unicast connection. Additionally, the UE 402 and/or UE 404 may include RLC parameters when establishing the unicast connection to set an RLC context for the unicast connection. For example, the RLC context may indicate whether an AM (e.g., a reordering timer (t-reordering) is used) or an unacknowledged mode (UM) is used for the RLC layer of the unicast communications.

Additionally, the UE 402 and/or UE 404 may include medium access control (MAC) parameters to set a MAC context for the unicast connection. In some cases, the MAC context may enable resource selection algorithms, a hybrid automatic repeat request (HARQ) feedback scheme (e.g., ACK or negative ACK (HACK) feedback), parameters for the HARQ feedback scheme, carrier aggregation, or a combination thereof for the unicast connection. Additionally, the UE 402 and/or UE 404 may include PHY layer parameters when establishing the unicast connection to set a PHY layer context for the unicast connection. For example, the PHY layer context may indicate a transmission format (unless transmission profiles are included for each UE 402/404) and a radio resource configuration (e.g., bandwidth part (BWP), numerology, etc.) for the unicast connection. These information elements may be supported for different frequency range configurations (e.g., FR1 and FR2).

In some cases, a security context may also be set for the unicast connection (e.g., after the connection establishment 425 message is transmitted). Before a security association (e.g., security context) is established between the UE 302 and UE 304, the sidelink signaling radio bearers 405 and 410 may not be protected. After a security association is established, the sidelink signaling radio bearers 405 and 410 may be protected. Accordingly, the security context may enable secure data transmissions over the unicast connection and the sidelink signaling radio bearers 405 and 410. Additionally, IP layer parameters (e.g., link-local IPv4 or IPv6 addresses) may also be negotiated. In some cases, the IP layer parameters may be negotiated by an upper layer control protocol running after RRC signaling is established (e.g., the unicast connection is established). As noted above, the UE 404 may base its decision on whether to accept or reject the connection request 415 on a particular service indicated for the unicast connection and/or the contents to be transmitted over the unicast connection (e.g., upper layer information). The particular service and/or contents may be also indicated by an upper layer control protocol running after RRC signaling is established.

After the unicast connection is established, the UE 402 and UE 404 may communicate using the unicast connection over a sidelink 430, where sidelink data 435 is transmitted between the two UEs 402 and 404. The sidelink 430 may correspond to sidelink 342 in FIGS. 3A and 3B. In some cases, the sidelink data 435 may include RRC messages transmitted between the two UEs 402 and 404. To maintain this unicast connection on sidelink 430, UE 402 and/or UE 404 may transmit a keep alive message (e.g., “RRCDirectLinkAlive” message, a fourth RRC message, etc.). In some cases, the keep alive message may be triggered periodically or on-demand (e.g., event-triggered). Accordingly, the triggering and transmission of the keep alive message may be invoked by UE 402 or by both UE 402 and UE 404. Additionally or alternatively, a MAC control element (CE) (e.g., defined over sidelink 430) may be used to monitor the status of the unicast connection on sidelink 430 and maintain the connection. When the unicast connection is no longer needed (e.g., UE 402 travels far enough away from UE 404), either UE 402 and/or UE 404 may start a release procedure to drop the unicast connection over sidelink 430. Accordingly, subsequent RRC messages may not be transmitted between UE 402 and UE 404 on the unicast connection.

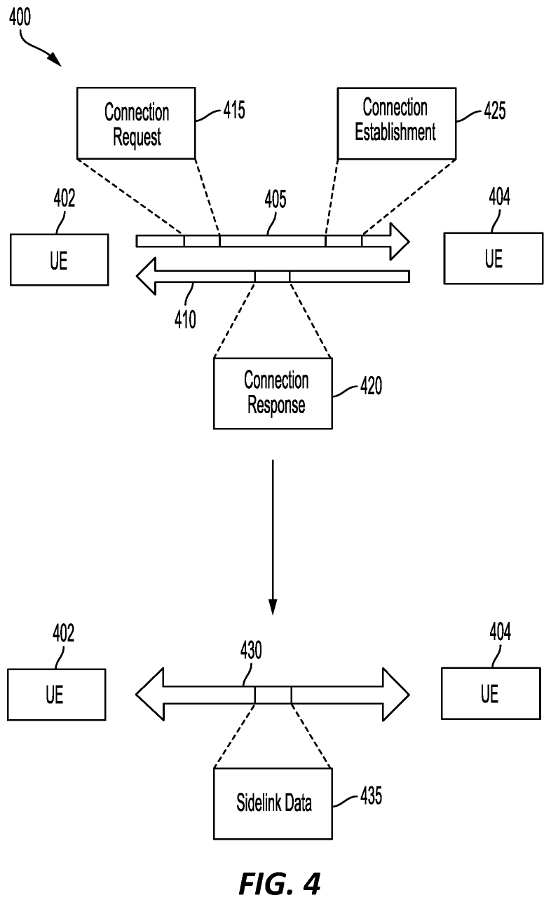

Communication over a sidelink may use a similar frame structure and numerology as used in LTE and NR. FIG. 5 is a diagram 500 illustrating an example of a frame structure for use on a sidelink, such as for transmitting a S-SSB, according to aspects of the disclosure. Other wireless communications technologies may have different frame structures and/or different channels.

In LTE and NR, the system bandwidth is partitioned into multiple (K) orthogonal subcarriers, which are also commonly referred to as tones, bins, etc. Each subcarrier may be modulated with data. In general, modulation symbols are sent in the frequency domain with orthogonal frequency division multiplexing (OFDM) and in the time domain with single-carrier frequency division multiplexing (SC-FDM). The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (u), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (us), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 us, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 us, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 us, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 us, and the maximum nominal system bandwidth (in MHz) with a 4K FFT size is 800.

In the example of FIG. 5, a numerology of 15 kHz is used. Thus, in the time domain, a 10 ms frame is divided into 10 equally sized subframes of 1 ms each, and each subframe includes one time slot. In FIG. 5, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 5, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Various sidelink physical channels can be transmitted on the resource elements of a slot of a radio frame. A sidelink physical channel corresponds to a set of resource elements carrying information originating from higher layers. The following sidelink physical channels are defined for NR sidelinks: a physical sidelink shared channel (PSSCH), a physical sidelink broadcast channel (PSBCH), a physical sidelink control channel (PSCCH), and a physical sidelink feedback channel (PSFCH). Examples of these channels are described in 3GPP Technical Specification (TS) 38.211.

As illustrated in FIG. 5, some of the resource elements carry physical RF signals. A sidelink physical signal corresponds to a set of resource elements used by the physical layer and does not carry information originating from higher layers. The following sidelink physical signals are defined for NR sidelinks: demodulation reference signals (DMRS), channel state information reference signals (CSI-RS), phase-tracking reference signals (PT-RS), sidelink primary synchronization signals (S-PSS), and sidelink secondary synchronization signals (S-SSS), example locations of which are labeled “R” in FIG. 5. These signals are described in 3GPP TS 38.211. In addition, a UE can transmit positioning reference signals (PRS), tracking reference signals (TRS), or the like for positioning purposes.

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

Note that the terms “positioning reference signal” and “PRS” generally refer to specific reference signals that are used for positioning in NR and LTE systems. However, as used herein, the terms “positioning reference signal” and “PRS” refer to any type of reference signal that can be used for positioning, such as but not limited to, PRS as defined in LTE and NR, tracking reference signals (TRS), phase tracking reference signals (PT-RS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), uplink positioning reference signals (UL-PRS), etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PT-RS) may be referred to as an “UL-PRS,” and a sidelink positioning reference signal may be referred to as an “SL-PRS.” In addition, for signals that may be transmitted in uplink, downlink, and sidelink directions (e.g., DMRS, PT-RS, etc.), the signals may be prepended with “UL,” “DL,” or “SL,” respectively, to distinguish the direction. For example, “UL-DMRS” may be differentiated from “SL-DMRS.”

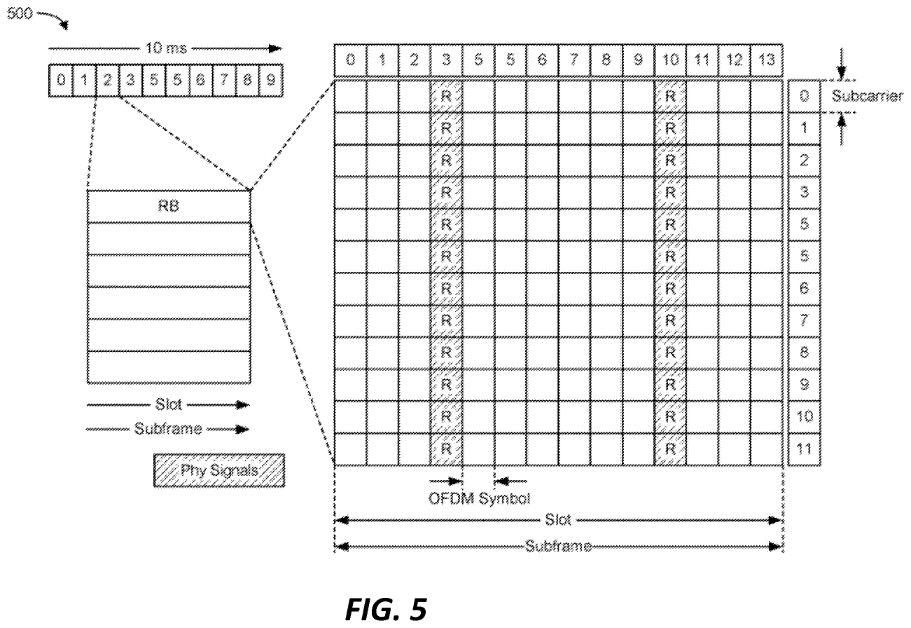

FIG. 6 is a block diagram illustrating an example wireless communication system 600 that supports transmission of power control configuration information according to one or more aspects.

In some examples, wireless communications system 600 may implement aspects of wireless network 100 and/or aspects of other wireless communications systems described herein. Wireless communications system 600 includes UEs 115a and 115b. Wireless communications system 300 may generally include multiple UEs 115, and may include one or more base station 105.

UE 115 may include a variety of components (such as structural, hardware components) used for carrying out one or more functions described herein. For example, these components may include one or more processors 602 (hereinafter referred to collectively as “processor 602”), one or more memory devices 604 (hereinafter referred to collectively as “memory 604”), one or more transmitters 616 (hereinafter referred to collectively as “transmitter 616”), and one or more receivers 618 (hereinafter referred to collectively as “receiver 618”). Processor 602 may be configured to execute instructions stored in memory 604 to perform the operations described herein. In some implementations, processor 602 includes or corresponds to one or more of receive processor 258, transmit processor 264, and controller 280, and memory 604 includes or corresponds to memory 282.

Memory 604 includes or is configured to store information (including, for example, power parameters) as part of a power configuration. Some portions of the power configuration may be sidelink positioning reference signal (SL PRS) power parameters including one or more of a specific SL transmit power, DL/UL pathloss value, transmit power strategy (e.g., specifying one of transmitting at Pₘₐₓ strategy, DL-pathloss based strategy, SL-pathloss based strategy, or DL and SL pathloss-based strategy). The parameters and other power information can be specified, for example, on a per-cluster ID and/or per-zone ID basis. The power information may also or alternatively specify a default power behavior. The default power behavior may be used in case the reference signal (RS) reference signal received power (RSRP) measurement fails, such that the UE operating in accordance with the power information has a default transmission power that should be used by the UE. The default power behavior may indicate to the UE to use a maximum power, to not transmit, or to use a previously-estimated power level.

Transmitter 616 is configured to transmit reference signals, control information and data to one or more other devices, and receiver 618 is configured to receive references signals, synchronization signals, control information and data from one or more other devices. For example, transmitter 616 may transmit signaling, control information and data to, and receiver 618 may receive signaling, control information and data from, base station 105. As another example, transmitter 616 may transmit power information, reference signals, synchronization signals, control information and data to another UE in a sidelink. In some implementations, transmitter 616 and receiver 618 may be integrated in one or more transceivers. Additionally or alternatively, transmitter 616 or receiver 618 may include or correspond to one or more components of UE 115 described with reference to FIG. 2.

UE 115b may include a variety of components (such as structural, hardware components) used for carrying out one or more functions described herein, such as in a similar configuration to that shown for UE 115a. For example, these components may include one or more processors 652 (hereinafter referred to collectively as “processor 652”), one or more memory devices 654 (hereinafter referred to collectively as “memory 654”), one or more transmitters 656 (hereinafter referred to collectively as “transmitter 656”), and one or more receivers 658 (hereinafter referred to collectively as “receiver 658”). Processor 652 may be configured to execute instructions stored in memory 654 to perform the operations described herein. In some implementations, processor 652 includes or corresponds to one or more of receive processor 238, transmit processor 220, and controller 240, and memory 354 includes or corresponds to memory 242. Memory 354 includes or is configured to store power information, such as power parameters received from UE 115a.

In some implementations, wireless communications system 600 implements a 5G NR network. For example, wireless communications system 600 may include multiple 5G-capable UEs 115, such as UEs configured to operate in accordance with a 5G NR network protocol such as that defined by the 3GPP.

During operation of wireless communications system 600, first UE 115a may have information that would be advantageous for second UE 115b to receive. For example, nearby UEs may benefit from sharing information to assist in performing power control for communications operations on a sidelink. In one example embodiment, power control configuration information may be shared from an in-coverage UE (the first UE 115a) to an out-of-coverage sidelink UE (the second UE 115b) to assist the UE 115b in adjusting power control parameters for operating on the sidelink. UEs can share path loss measurements (e.g., from their own cell), and use the shared path loss measurement, in combination with its own measurement, to determine a transmission power for the sidelink. UEs can share power control parameters through the sidelink. UEs can coordinate in groups to share information. The first UE 115a can relay another UE's information (e.g., a third UE 115c), including power control parameters and/or other power information, to the second UE 115b. The confidence level of the shared information may be determined, by the receiving UE, based on one or more of a pathloss, a distance, and/or a RSRP of the sidelink. In some embodiments, the second UE 115b may use the shared information from a UE whose path loss is below a threshold. In some embodiments, sharing of information may be based on a request by other UEs and/or gNBs.

As described with reference to FIG. 3, the present disclosure provides techniques for sharing power configuration, such as transmit power levels for reference signals, to control transmission on a sidelink. One example use of a sidelink is for positioning of the UEs. In SL positioning, a SL UE transmits a SL PRS, which is received by other SL UEs. The SL PRS may be used to determine location of one or more UEs in the wireless network. Determining an appropriate SL PRS transmit power level can improve the positioning process (in reducing time used to locate position and in increasing accuracy of the position), in addition to saving SL UE power, and reducing potential interference caused by a SL PRS transmission at too-high power levels. A SL UE transmitting a SL PRS may determine the appropriate SL PRS transmit power level in a quicker and/or more accurate manner by receiving SL PRS power configuration from nearby UEs and basing its own SL PRS transmit power level on the received SL PRS power configuration. Thus, the sharing of power information for a SL and controlling transmissions on the SL according to aspects of this disclosure may improve SL positioning and otherwise improve operation on the sidelink. Further, many nearby UEs may benefit from receiving the same power configuration, and the power configuration can be shared to a specific UE or can be broadcast or groupcast to multiple UEs, in which recipient UEs may be determined based on specific location zones or other groupings.

Referring again to FIG. 6, the first UE 115a may have a power configuration 683 stored in memory 604, in which the power configuration 683 may have been refined over a period of time by the first UE 115a. The UE 115a may share the power configuration 683 over a sidelink 610 to the second UE 115b. For example, the first UE 115a may transmit power configuration in message 680 to the second UE 115b. The message 680 may include, for example, power information as an indicator of the power configuration. The indicator may include a representation of or the actual information in at least a portion of the power configuration 683.

The first UE 115a may transmit the message 680 based on one or more criteria. For example, the first UE 115a may have a timer that executes to determine a schedule for transmitting message 680. As another example, the first UE 115a may transmit the message 680 upon detecting the presence of the second UE 115b. In yet another example, the first UE 115a may transmit the message 680 in response to a request message 670 transmitted by the second UE 115b requesting power configuration information.

The second UE 115b may receive the message 680 and store the power configuration information as power configuration 682 in memory 654. The second UE 115b may use the power configuration 682 to determine parameters for transmitting and/or receiving using the transmitter 656 and the receiver 658. For example, the second UE 115b may determine a SL PRS transmit power level for controlling the transmitter 656 using the power configuration information 682. The UE 115b may further refine the power configuration 682 based on additional information and/or measurements by the UE 115b.

Operation of the first UE 115a and the second UE 115b are described in more detail with reference to FIG. 7 and FIG. 8, respectively.

FIG. 7 is a flow diagram illustrating an example process that supports transmitting power control configuration information on a sideline according to one or more aspects.

Operations of method 700 may be performed by a UE, such as UE 115a described above with reference to FIGS. 1, 2, 6, or a UE described with reference to FIGS. 3A and 3B. For example, example operations (also referred to as “blocks”) of process 700 may enable UE 115 to support sharing of power configuration information through a sidelink.

In block 702, a first UE, the UE sharing its power configuration information may retrieve first information regarding power control for a sidelink transmission. The power information retrieved may include a p0 parameter, an alpha parameter, SL transmit power, DL/UL pathloss value, transmit power strategy (e.g., specifying one of transmitting at Pₘₐₓ strategy, DL-pathloss based strategy, SL-pathloss based strategy, or DL and SL pathloss-based strategy).

In block 704, the first UE may transmit to a second UE at least one indicator based on the first information. The transmission may be over a SL, such as SL 342 of FIGS. 3A-B. For example, the first UE may share SL PRS power parameters with the second UE. The transmission may include an indicator for SL PRS power parameters, a representation (e.g., one of several integer values indicating one of several possible values for the parameter, a coded version of the parameter value, or the parameter value itself) of one or more of a specific SL transmit power, DL/UL pathloss value, and/or a transmit power strategy to use (e.g., a first strategy to transmit at Pₘₐₓ, a second strategy based on DL-pathloss, a third strategy based on SL-pathloss, and/or a fourth strategy based on DL & SL pathloss). The first information may also or alternatively include a default power behavior, such as an indication of a transmit power used by the second UE when the reference RS RSRP measurement fails. For example, the indication may indicate one of transmitting at maximum power, not transmitting, or using a previously estimated power.

The transmission of block 704 may include one or more UEs broadcasting or groupcasting sidelink power information (including a sidelink configuration) as one or more first UEs transmitting to a second UE.

In some implementations, the method 700 is UE-initiated. A new UE, such as the second UE when first initializing on a wireless communications system or first initializing a sidelink, requests from another UE, such as the first UE, power parameters for the sidelink. In response to the request, the first UE may perform the method 700. In a UE-initiated communication session, the first UE may be the cluster leader or cluster initiator (e.g., Init-anchor).

In some implementations, the method 700 is performed as unsolicited power parameter sharing. For example, the first UE may execute blocks 702 and 704 to transmit power information when the second UE advertises its presence.

In some implementations, the first UE may execute method 700 only for transmission to a second UE that is in the same cluster or only for transmission to a second UE that is in the same cluster and the same zone. In these implementations, the first UE may determine, prior to block 702, whether the second UE is in the same cluster and whether the second UE is in the same zone.

In some implementations, the first UE may be a roadside unit (RSU)-type UE, in which the first UE includes in a transmitted beacon the SL power parameters or other configuration information, such as configuration information the UE is expecting from newly-added UEs. In some embodiments, the beacon could be transmitted in a configuration that is repeated periodically, such as in a system information block (SIB) or a UE-specific transmission. In a wireless system in which the RSU only transmits sidelink-synchronization signal blocks (S-SSBs) and does not periodically transmit SIBs, the SL power parameters or other configuration information may be included in UE-specific or group-specific messages.

FIG. 8 is a flow diagram illustrating an example process that supports receiving power control configuration information on a sideline for configuring a UE according to one or more aspects.

Operations of process 800 may be performed by a UE, such as UE 115 described above with reference to FIGS. 1, 2, 6, or a UE described with reference to FIGS. 3A and 3B. For example, example operations (also referred to as “blocks”) of process 800 may enable UE 115 to support sharing of power configuration information through a sidelink.

In block 802, the second UE receives from the first UE the first information regarding power control for a sidelink transmission. The information received at block 802 may correspond to any of the information described with respect to the transmission of first information at block 702. The received information may be received in a broadcast or multicast message.

In block 804, the second UE may transmit on the sidelink transmission according to the first information regarding power control for the sidelink transmission received at block 802. The UE may, for example, transmit a SL PRS signal on the SL according to the first information. In some embodiments, the transmission may be based on the first information by refining initial power control parameters received at block 802 and transmitting at the refined power control parameters. The SL PRS signal may be used as part of a positioning operation by the second UE, the first UE, or other wireless devices in range of the second UE.

In some implementations, the second UE may transmit the first information to additional UEs, such as a third UE to share the power control information with more UEs.

In some implementations, prior to the receiving of block 802, the second UE may request power control information implicitly by advertising its presence and/or explicitly by transmitting a request for the power control information, which causes the first UE to transmit at block 704.

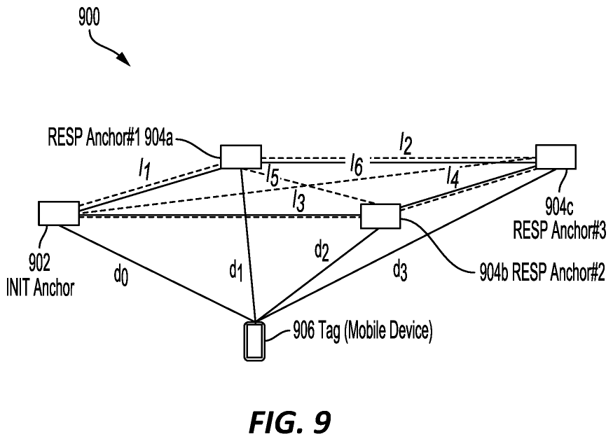

An example positioning operation using sidelink information as described above is shown in FIG. 9. FIG. 9 is a diagram illustrating an example communication system for sidelink communications of power control parameters used for sidelink positioning reference signals (SL-PRS) transmissions according to one or more aspects. An INIT anchor 902 (e.g., the UE that initializes a positioning determination), may include in an initialization message power control parameters for sharing with other UEs. The responding anchors 904a-c may include in their transmitted messages, power control parameters used for SL-PRS transmissions.

Regarding initialization, the INIT anchor 902 may include a current SL PRS transmission power level of the INIT anchor 902 (e.g., information regarding the transmit power used in SL-PRS, information regarding a reference signal used to derive the power control for the INIT anchor 902, information regarding the “alpha” parameter, and/or information regarding one or more “p0” parameters. The alpha and p0 parameters may be used in an equation for determining a transmit power level, such as when the alpha parameter is a fractional power control value and the “p0” parameter is a nominal power level. As another example, the INIT anchor 902 may include in the initialization message the SL-PRS transmissions of one or more of responding anchors 904a-c. In some implementations, this message may include a list of anchor IDs for responding anchors 904a-c with a list of corresponding power control parameters or other information. In some implementations, this message may include power control parameters for each zone-ID or for an entire cluster.

A mobile device 906, such as a third UE, may determine its location based on the transmission of data over sidelinks 11-16 between one or more of the INIT anchor 902 and/or responding anchors 904a-c. Device 906 may receive SL PRS transmissions from anchors 902 and 904a-c along paths with distances d₀-d₃, respectively. The PRS signals transmitted by one or more of the anchors 904a-c may be based on power information transmitted through one or more of the SLs 11-16. In some embodiments, the mobile device 906 may not receive the power information that is transmitted over SLs 11-16. In some embodiments, the mobile device 906 may receive power information similar to what is transmitted over SLs 11-16. For example, the mobile device 906 can benefit from receiving the parameters even if it does not transmit itself a SL SRS because by knowing the transmit power level and estimating the pathloss, the mobile device 906 can roughly estimate the range based on path loss (as a first range estimation to the different anchors 902 and 904a-c).

In one example positioning operation involving the PRS signals, the mobile device 906 may determine time difference of arrivals (TDOAs) TDOA₁-TDOA₃ corresponding to measurements of distances d₁-d₃ with each of the responding anchors 904a-c, with the measurements using a reference distance do between the mobile device 906 and the INIT anchor 902 based on the following equations:

$${TDOA}_{1} = ( {d}_{1} - {d}_{0} ) / c$$

$${TDOA}_{2} = ( {d}_{2} - {d}_{0} ) / c$$

$${TDOA}_{3} = ( {d}_{3} - {d}_{0} ) / c$$

In some embodiments, the INIT anchor 902 may receive the measurements from the device 906 and perform the determinations of the values d₀-d₃ and TDOA₁-TDOA₃ to determine the position of the device 906. In some embodiments, the device 906 may perform the measurements, perform the determinations of the values d₀-d₃ and TDOA₁-TDOA₃ and report the position to INIT anchor 902.

Positioning operations, such as the TDOA determination, may be improved by using the transmitted parameters for the PRS signal, which optimizes the power of the transmitted PRS signal by providing a good signal-to-noise ratio (SNR) at the intended receiver. The use of the transmitted parameters may reduce receiver saturation issues resulting from transmission levels being too high and may reduce noise issues that reduce the accuracy of the time-of-flight estimation resulting from transmission levels being too low.

Communications may include transmission of power control information from INIT anchor 902 to the responding anchors 904a-c, but also may include transmission of power control information and/or other information and commands from the responding anchors 904a-c to INIT anchor 902. For example, the INIT anchor 902 may transmit a unicast, broadcast, or multicast message including increase or decrease transmit power commands to responding anchors 904a-c to be used for future closed loop power control based on SL PRS. The responding anchors 904a-c may share power information with the INIT anchor 902, upon which the INIT anchor 902 determines additional power adjustments for one or more of the responding anchors 904a-c.

The INIT anchor 902 may transmit to the responding anchors 904a-c as part of a positioning operation. For example, the INIT anchor 902 may receive a positioning request from a target device, such as mobile device 906. The INIT anchor 902 may initiate the operation by transmitting power information, such as a reference to derive power control on the SL PRS including a alpha and p0 parameter. One or more of the responding anchors 904a-c may respond with a list of anchor IDs and a list of power control parameters. One or more of the responding anchors 904a-c may alternatively respond with power control parameters for each zone-ID or for the entire cluster of anchors 902 and 904a-c. The responding anchors 904a-c may additionally or alternatively include in a response to the INIT anchor 902 power information that may be used for SL PRS transmissions by the INIT anchor 902 and/or other responding anchors 904a-c.

In some embodiments, a target device may transmit a unicast, broadcast, or multicast message back to the INIT anchor 902 and or other anchors 904a-c. The target devices' message may include changing the reference signal (RS). As a further example, a target device may transmit a unicast, broadcast, or multicast message including commands to change the “p0” and/or “alpha” parameters. In some implementations, each one of the transmitted responses may be associated with a specific cluster-ID, zone-ID, anchor-ID, or group of anchor-IDs. The target device may send that message to the INIT anchor 902 only, such that the INIT anchor 902 may update common power control parameters at all participating devices.

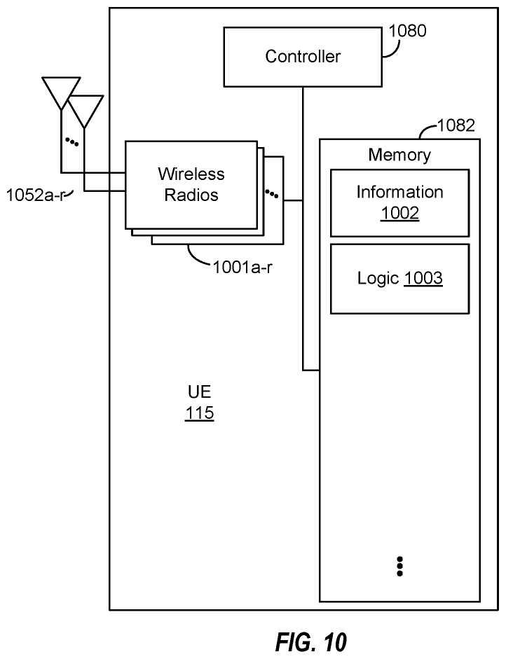

FIG. 10 is a block diagram of an example UE 1000 that supports sharing of power configuration information over a sidelink according to one or more aspects. UE 1000 may be configured to perform operations, including the blocks of a process described with reference to FIGS. 7-8. In some implementations, UE 1000 includes the structure, hardware, and components shown and described with reference to UE 115 of FIGS. 1-2. For example, UE 1000 includes controller 1080, which operates to execute logic or computer instructions stored in memory 1082, as well as controlling the components of UE 1000 that provide the features and functionality of UE 1000. UE 1000, under control of controller 1080, transmits and receives signals via wireless radios 1001a-r and antennas 1052a-r. Wireless radios 1001a-r include various components and hardware, as illustrated in FIG. 2 for UE 115, including modulator and demodulators 254a-r, MIMO detector 256, receive processor 258, transmit processor 264, and TX MIMO processor 266.

As shown, memory 1082 may include information 1002, such as a power configuration, logic 1003, such as code for determining when to transmit information including the power configuration information. UE 1000 may receive signals from or transmit signals to one or more network entities, such as base station 105 of FIGS. 1-2.

It is noted that one or more blocks (or operations) described with reference to FIGS. 6-8 may be combined with one or more blocks (or operations) described with reference to another of the figures. For example, one or more blocks (or operations) of FIG. 6 may be combined with one or more blocks (or operations) of FIG. 7. As another example, one or more blocks associated with FIG. 6 may be combined with one or more blocks associated with FIG. 8. As a further example, one or more blocks associated with FIG. 7 may be combined with one or more blocks associated with FIG. 8. As another example, one or more blocks associated with FIGS. 6-8 may be combined with one or more blocks (or operations) associated with FIGS. 1-5. Additionally, or alternatively, one or more operations described above with reference to FIGS. 1-6 may be combined with one or more operations described with reference to FIG. 10.

In one or more aspects, techniques for supporting wireless communications, including positioning operations, may include additional aspects, such as any single aspect or any combination of aspects described below or in connection with one or more other processes or devices described elsewhere herein. In a first aspect, supporting wireless communications may include an apparatus configured to retrieving, by the first UE, first information regarding power control for a sidelink transmission. The apparatus is further configured to transmitting, by the first UE to a second UE, at least one indicator based on the first information. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the apparatus is further configured to perform operations including receiving, by the first UE from the second UE, a transmission from the second UE, wherein transmitting the at least one indicator is based on receiving the transmission.

In a third aspect, in combination with one or more of the first aspect or the second aspect, the transmission comprises a request for the at least one indicator.

In a fourth aspect, in combination with one or more of the first aspect through the third aspect, the apparatus is further configured to perform operations including determining, by the first UE in response to receiving the transmission, that the second UE is in a first cluster along with the first UE, wherein transmitting the at least one indicator is based on determining that the second UE is in the first cluster along with the first UE.

In a fifth aspect, in combination with one or more of the first aspect through the fourth aspect, the apparatus is further configured to perform operations including determining, by the first UE in response to receiving the transmission, that the second UE is in a first zone along with the first UE, wherein transmitting the at least one indicator is based on determining that the second UE is in the first zone along with the first UE.

In a sixth aspect, in combination with one or more of the first aspect through the fifth aspect, the first information comprises a power control parameter stored by the first UE.

In a seventh aspect, in combination with one or more of the first aspect through the sixth aspect, the power control parameter comprises at least one of a sidelink transmit power, a downlink pathloss value, an uplink pathloss value an indicator of a transmit power strategy, or a default power behavior.

In an eighth aspect, in combination with one or more of the first aspect through the seventh aspect, the first UE comprises a roadside unit (RSU)-type UE, and wherein transmitting the at least one indicator comprises transmitting, by the RSU-type UE, a beacon comprising the at least one indicator.

In a ninth aspect, in combination with one or more of the first aspect through the eighth aspect, the apparatus is further configured to perform operations including receiving, by the first UE from a third UE, a second power control configuration; and transmitting, by the first UE to the second UE, a second indicator based on the second power control configuration.

In one or more aspects, techniques for supporting wireless communications, including positioning operations, may include additional aspects, such as any single aspect or any combination of aspects described below or in connection with one or more other processes or devices described elsewhere herein. In a tenth aspect, supporting wireless communications may include an apparatus configured to receiving, from a first UE at a second UE, first information regarding power control for a sidelink transmission. The apparatus is further configured to transmitting, by the second UE, on the sidelink transmission according to the first information regarding power control for the sidelink transmission. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In an eleventh aspect, in combination with one or more of the first aspect through the tenth aspect, transmitting on the sidelink transmission comprises transmitting a positioning reference signal (PRS).

In a twelfth aspect, in combination with one or more of the first aspect through the eleventh aspect, the apparatus is further configured to perform operations including transmitting, by the second UE, a notification of a presence of the second UE.

In a thirteenth aspect, in combination with one or more of the first aspect through the twelfth aspect, the apparatus is further configured to perform operations including transmitting, by the second UE, a request for the at least one indicator.

In a fourteenth aspect, in combination with one or more of the first aspect through the thirteenth aspect, the apparatus is further configured to perform operations including determining, by the second UE, that the second UE is in a first cluster along with the first UE, wherein receiving the first information is based on determining that the second UE is in the first cluster along with the first UE.

In a fifteenth aspect, in combination with one or more of the first aspect through the fourteenth aspect, the apparatus is further configured to perform operations including determining, by the second UE, that the second UE in is in a first zone along with the first UE, wherein receiving the first information is based on determining that the second UE is in the first zone along with the first UE.

In a sixteenth aspect, in combination with one or more of the first aspect through the fifteenth aspect, the power control parameter comprises at least one of a sidelink transmit power, a downlink pathloss value, an uplink pathloss value an indicator of a transmit power strategy, or a default power behavior.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a first user equipment (UE), the method comprising:
retrieving, by the first UE, first information regarding power control for a sidelink transmission; and
transmitting, by the first UE to a second UE, at least one indicator based on the first information.

2. The method of claim 1, further comprising:
receiving, by the first UE from the second UE, a transmission from the second UE,
wherein transmitting the at least one indicator is based on receiving the transmission.

3. The method of claim 2, wherein the transmission comprises a request for the at least one indicator.

4. The method of claim 2, further comprising:
determining, by the first UE in response to receiving the transmission, that the second UE is in a first cluster along with the first UE,
wherein transmitting the at least one indicator is based on determining that the second UE is in the first cluster along with the first UE.

5. The method of claim 2, further comprising:
determining, by the first UE in response to receiving the transmission, that the second UE is in a first zone along with the first UE,
wherein transmitting the at least one indicator is based on determining that the second UE is in the first zone along with the first UE.

6. The method of claim 1, wherein the first information comprises a power control parameter stored by the first UE.

7. The method of claim 6, wherein the power control parameter comprises at least one of a sidelink transmit power, a downlink pathloss value, an uplink pathloss value an indicator of a transmit power strategy, or a default power behavior.

8. The method of claim 6, wherein the first UE comprises a roadside unit (RSU)-type UE, and wherein transmitting the at least one indicator comprises transmitting, by the RSU-type UE, a beacon comprising the at least one indicator.

9. The method of claim 1, further comprising:
receiving, by the first UE from a third UE, a second power control configuration; and
transmitting, by the first UE to the second UE, a second indicator based on the second power control configuration.

10. A method of wireless communication, the method comprising:
receiving, from a first UE at a second UE, first information regarding power control for a sidelink transmission; and
transmitting, by the second UE, on the sidelink transmission according to the first information regarding power control for the sidelink transmission.

11. The method of claim 10, wherein transmitting on the sidelink transmission comprises transmitting a positioning reference signal (PRS).

12. The method of claim 10, further comprising transmitting, by the second UE, a notification of a presence of the second UE.

13. The method of claim 10, further comprising transmitting, by the second UE, a request for the first information.

14. The method of claim 10, further comprising:
determining, by the second UE, that the second UE is in a first cluster along with the first UE,
wherein receiving the first information is based on determining that the second UE is in the first cluster along with the first UE.

15. The method of claim 10, further comprising:
determining, by the second UE, that the second UE in is in a first zone along with the first UE,
wherein receiving the first information is based on determining that the second UE is in the first zone along with the first UE.

16. The method of claim 10, wherein the first information comprises at least one of a sidelink transmit power, a downlink pathloss value, an uplink pathloss value an indicator of a transmit power strategy, or a default power behavior.

17. A first user equipment (UE) comprising:
a memory storing processor-readable code; and
at least one processor coupled to the memory, the at least one processor configured to execute the processor-readable code to cause the at least one processor to perform operations including:
retrieving, by the first UE, first information regarding power control for a sidelink transmission; and
transmitting, by the first UE to a second UE, at least one indicator based on the first information.

18. The UE of claim 17, wherein the at least one processor is configured to execute the processor-readable code to further cause the at least one processor to perform operations including:
receiving, by the first UE from the second UE, a transmission from the second UE,
wherein transmitting the at least one indicator is based on receiving the transmission.

19. The UE of claim 18, wherein the transmission comprises a request for the at least one indicator.

20. The UE of claim 18, wherein the at least one processor is configured to execute the processor-readable code to further cause the at least one processor to perform operations including:
determining, by the first UE in response to receiving the transmission, that the second UE is in a first cluster along with the first UE,
wherein transmitting the at least one indicator is based on determining that the second UE is in the first cluster along with the first UE.

21. The UE of claim 18, wherein the at least one processor is configured to execute the processor-readable code to further cause the at least one processor to perform operations including:
determining, by the first UE in response to receiving the transmission, that the second UE is in a first zone along with the first UE,
wherein transmitting the at least one indicator is based on determining that the second UE is in the first zone along with the first UE.

22. The UE of claim 17, wherein the first information comprises a power control parameter stored by the first UE.

23. The UE of claim 22, wherein the power control parameter comprises at least one of a sidelink transmit power, a downlink pathloss value, an uplink pathloss value an indicator of a transmit power strategy, or a default power behavior.

24. The UE of claim 22, wherein the first UE comprises a roadside unit (RSU)-type UE, and wherein transmitting the at least one indicator comprises transmitting, by the RSU-type UE, a beacon comprising the at least one indicator.

25. The UE of claim 17, wherein the at least one processor is configured to execute the processor-readable code to further cause the at least one processor to perform operations including:
receiving, by the first UE from a third UE, a second power control configuration; and
transmitting, by the first UE to the second UE, a second indicator based on the second power control configuration.

26. A user equipment (UE) comprising:
a memory storing processor-readable code; and
at least one processor coupled to the memory, the at least one processor configured to execute the processor-readable code to cause the at least one processor to perform operations including:
receiving, from a first UE at a second UE, first information regarding power control for a sidelink transmission; and
transmitting, by the second UE, on the sidelink transmission according to the first information regarding power control for the sidelink transmission.

27. The UE of claim 26, wherein transmitting on the sidelink transmission comprises transmitting a positioning reference signal (PRS).

28. The UE of claim 26, wherein the at least one processor is configured to execute the processor-readable code to further cause the at least one processor to perform operations including:
transmitting, by the second UE, a request for the first information.

29. The UE of claim 26, wherein the at least one processor is configured to execute the processor-readable code to further cause the at least one processor to perform operations including:
determining, by the second UE, that the second UE is in a first cluster along with the first UE,
wherein receiving the first information is based on determining that the second UE is in the first cluster along with the first UE.

30. The UE of claim 26, wherein the first information comprises at least one of a sidelink transmit power, a downlink pathloss value, an uplink pathloss value an indicator of a transmit power strategy, or a default power behavior.
